(19) United States
(12) Patent Application Publication
(10) Pub. No.: US 2014/0060362 A1
(43) Pub. Date: Mar. 6, 2014

(54) IMAGING MEMBER FOR OFFSET PRINTING APPLICATIONS

(71) Applicants: Mandakini KANUNGO, Penfield, NY (US); Maryna ORNATSKA, Hightstown, NJ (US); David J. GERVASI, Pittsford, NY (US); Patrick J. HOWE, Fairport, NY (US); Santokh S. BADESHA, Pittsford, NY (US); Matthew M. Kelly, West Henrietta, NY (US)

(72) Inventors: Mandakini KANUNGO, Penfield, NY (US); Maryna ORNATSKA, Hightstown, NJ (US); David J. GERVASI, Pittsford, NY (US); Patrick J. HOWE, Fairport, NY (US); Santokh S. BADESHA, Pittsford, NY (US); Matthew M. Kelly, West Henrietta, NY (US)

(73) Assignee: XEROX CORPORATION, Norwalk, CT (US)

(21) Appl. No.: 13/601,962

(22) Filed: Aug. 31, 2012

(51) Int. Cl. B41F 1/18; B29C 39/00; G02B 5/22; B82Y 30/00

(52) U.S. Cl. 101/450.1; 252/587; 264/299; 977/773

(57) ABSTRACT

An imaging member includes a surface layer comprising a silicone rubber and an infrared-absorbing filler. Methods of fabricating the imaging member and processes for variable lithographic printing using the imaging member are also disclosed.

### RELATED APPLICATIONS

The disclosure is related to U.S. patent application Ser. No. 13/095,714, filed on Apr. 27, 2011, titled “Variable Data Lithography System,” the disclosure of which is incorporated herein by reference in its entirety. The disclosure is related to co-pending U.S. patent application (Attorney Docket No. 056-0512), filed on the same day as the present disclosure, titled “Imaging Member for Offset Printing Applications,” the disclosure of which is incorporated herein by reference in its entirety; co-pending U.S. patent application (Attorney Docket No. 056-0511), filed on the same day as the present disclosure, titled “Imaging Member for Offset Printing Applications,” the disclosure of which is incorporated herein by reference in its entirety; co-pending U.S. Patent Application (Attorney Docket No. 056-0510), filed on the same day as the present disclosure, titled “Imaging Member for Offset Printing Applications,” the disclosure of which is incorporated herein by reference in its entirety; co-pending U.S. patent application (Attorney Docket No. 056-0509), filed on the same day as the present disclosure, titled “Textured Imaging Member,” the disclosure of which is incorporated herein by reference in its entirety; co-pending U.S. patent application (Attorney Docket No. 056-0508), filed on the same day as the present disclosure, titled “Imaging Member for Offset Printing Applications,” the disclosure of which is incorporated herein by reference in its entirety; co-pending U.S. patent application (Attorney Docket No. 056-0507), filed on the same day as the present disclosure, titled “Variable Lithographic Printing Process,” the disclosure of which is incorporated herein by reference in its entirety; co-pending U.S. patent application (Attorney Docket No. 056-0506), filed on the same day as the present disclosure, titled “Imaging Member for Offset Printing Applications,” the disclosure of which is incorporated herein by reference in its entirety; co-pending U.S. patent application (Attorney Docket No. 056-0505), filed on the same day as the present disclosure, titled “Printing Plates Doped With Release Oils,” the disclosure of which is incorporated herein by reference in its entirety; co-pending U.S. patent application (Attorney Docket No. 056-0504), filed on the same day as the present disclosure, titled “Imaging Member,” the disclosure of which is incorporated herein by reference in its entirety; and co-pending U.S. patent application (Attorney Docket No. 056-0451), filed on the same day as the present disclosure, titled “Methods and Systems for Ink-Based Digital Printing With Multi-Component, Multi-Functional Fountain Solution,” the disclosure of which is incorporated herein by reference in its entirety.

### FIELD OF DISCLOSURE

The present disclosure is related to imaging members having a surface layer containing heat treated carbon black. The imaging members are suitable for use in various marking and printing methods and systems, such as offset printing. The present disclosure provides processes for heat treating carbon black to improve polymer curing. The present disclosure also permits methods and systems providing control of conditions local to the point of writing data to a reimageable surface in variable data lithographic systems. Methods of making and using such imaging members are also disclosed.

### BACKGROUND

Offset lithography is a common method of printing today. (For the purposes hereof, the terms “printing” and “marking” are interchangeable.) In a typical lithographic process a printing plate, which may be a flat plate, the surface of a cylinder, or belt, etc., is formed to have “image regions” formed of a hydrophobic/oleophilic material, and “non-image regions” formed of a hydrophilic/oleophobic material. The image regions correspond to the areas on the final print (i.e., the target substrate) that are occupied by a printing or marking material such as ink, whereas the non-image regions correspond to the areas on the final print that are not occupied by said marking material. The hydrophilic regions accept and are readily wetted by a water-based fluid, commonly referred to as a dampening fluid or fountain solution (typically consisting of water and a small amount of alcohol as well as other additives and/or surfactants to reduce surface tension). The hydrophobic regions repel dampening fluid and accept ink, whereas the dampening fluid formed over the hydrophilic regions forms a fluid “release layer” for rejecting ink. The hydrophilic regions of the printing plate thus correspond to unprinted areas, or “non-image areas”, of the final print.

The ink may be transferred directly to a target substrate, such as paper, or may be applied to an intermediate surface, such as an offset (or blanket) cylinder in an offset printing system. The offset cylinder is covered with a conformable coating or sleeve with a surface that can conform to the texture of the target substrate, which may have surface peak-to-valley depth somewhat greater than the surface peak-to-valley depth of the imaging plate. Also, the surface roughness of the offset blanket cylinder helps to deliver a more uniform layer of printing material to the target substrate free of defects such as mottle. Sufficient pressure is used to transfer the image from the offset cylinder to the target substrate. Pinching the target substrate between the offset cylinder and an impression cylinder provides this pressure.

Typical lithographic and offset printing techniques utilize plates which are permanently patterned, and are therefore useful only when printing a large number of copies of the same image (i.e. long print runs), such as magazines, newspapers, and the like. However, they do not permit creating and printing a new pattern from one page to the next without removing and replacing the print cylinder and/or the imaging plate (i.e., the technique cannot accommodate true high speed variable data printing wherein the image changes from impression to impression, for example, as in the case of digital printing systems). Furthermore, the cost of the permanently patterned imaging plates or cylinders is amortized over the number of copies. The cost per printed copy is therefore higher for shorter print runs of the same image than for longer print runs of the same image, as opposed to prints from digital printing systems.

Accordingly, a lithographic technique, referred to as variable data lithography, has been developed which uses a non-patterned reimageable surface that is initially uniformly coated with a dampening fluid layer. Regions of the dampening fluid are removed by exposure to a focused radiation source (e.g., a laser light source) to form pockets. A temporary pattern in the dampening fluid is thereby formed over the non-patterned reimageable surface. Ink applied thereover is retained in the pockets formed by the removal of the dampening fluid. The inked surface is then brought into contact with a substrate, and the ink transfers from the pockets in the dampening fluid layer to the substrate. The dampening fluid may then be removed, a new uniform layer of dampening fluid applied to the reimageable surface, and the process repeated.

It is desirable to identify alternate materials that are suitable for use for imaging members in variable data lithography. It would also be desirable to identify methods/processes for making/producing materials that are better suited for use in such applications.

### SUMMARY

The present disclosure relates to imaging members for digital offset printing applications. The imaging members have a surface layer made of a silicone rubber and a heat-treated carbon black. The carbon black acts as an infrared-absorbing filler, and does not affect the curing of the silicone rubber.

In an embodiment, an imaging member may include a surface layer; wherein the surface layer comprises a silicone rubber and heat treated carbon black; and wherein the carbon black has been heat treated at a temperature of at least 445° C. In an embodiment, the silicone rubber may be present in an amount of from about 80 to about 95 weight percent.

In an embodiment, the carbon black may be present in amount of from about 5 to about 20 weight percent. The carbon black may have an average particle size of from about 2 nanometers to about 10 microns. The carbon black may be heat treated to a temperature of at least 550° C. The carbon black may be heat treated for a period of from about 30 minutes to about 2 hours. The carbon black may be heat treated to a temperature of about 600° C. for a period of about 1 hour.

In an embodiment, methods of fabricating an imaging member surface layer may include depositing a surface layer composition upon a mold; and curing the surface layer composition; wherein the surface layer composition comprises a silicone material and a heat treated carbon black; and wherein the carbon black has been heat treated at a temperature of at least 445° C.

In an embodiment, the curing may occur at about room temperature. The surface layer composition may further include a catalyst. In an embodiment, the catalyst may be a platinum catalyst. In an embodiment, the carbon black may be present in an amount of about 5 to about 20 weight percent. The carbon black may have an average particle size of from about 2 nanometers to about 10 microns. In an embodiment, the vulcanized surface layer may have a thickness of from about 0.5 microns to about 4 millimeters.

In an embodiment, processes for variable lithographic printing, may include applying a fountain solution to an imaging member comprising an imaging member surface; forming a latent image by evaporating the fountain solution from selective locations on the imaging member surface to form hydrophobic non-image areas and hydrophilic image areas; developing the latent image by applying an ink composition to the hydrophilic image areas; and transferring the developed latent image to a receiving substrate; wherein the imaging member surface comprises a silicone rubber and heat treated carbon black; and wherein the carbon black has been heat treated at a temperature of at least 445° C.

In an embodiment, the fountain solution may include a siloxane compound. In an embodiment, the siloxane compound is octamethylcyclotetrasiloxane. The carbon black may be present in an amount of about 5 to about 20 weight percent. In an embodiment, the carbon black has an average particle size of from about 2 nanometers to about 10 microns.

Exemplary embodiments are described herein. It is envisioned, however, that any system that incorporates features of apparatus, systems, and methods described herein are encompassed by the scope and spirit of the exemplary embodiments.

The patent or application file contains at least one drawing executed in color. Copies of this patent or patent application publication with color drawing(s) will be provided by the Office upon request and payment of the necessary fee.

The following is a brief description of the drawings, which are presented for the purposes of illustrating the exemplary embodiments disclosed herein and not for the purposes of limiting the same.

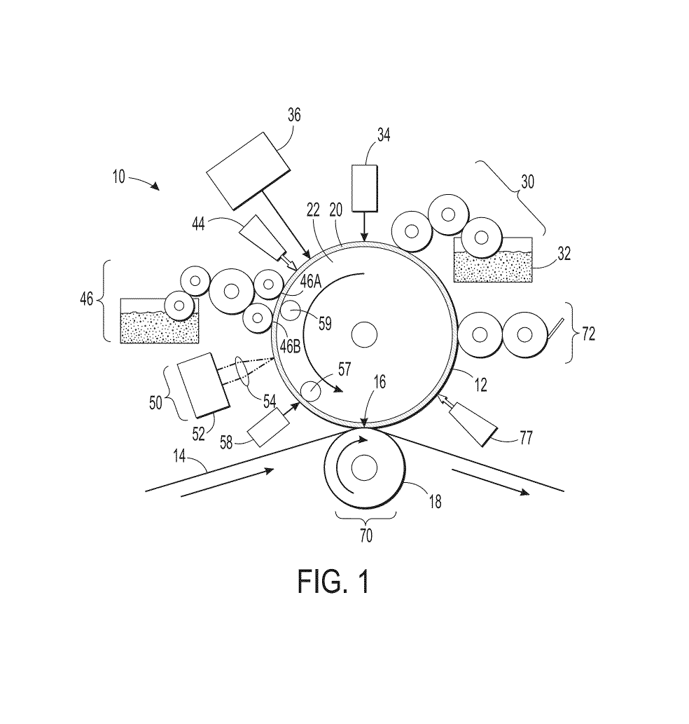

FIG. 1 illustrates a variable lithographic printing apparatus in which the dampening fluids of the present disclosure may be used.

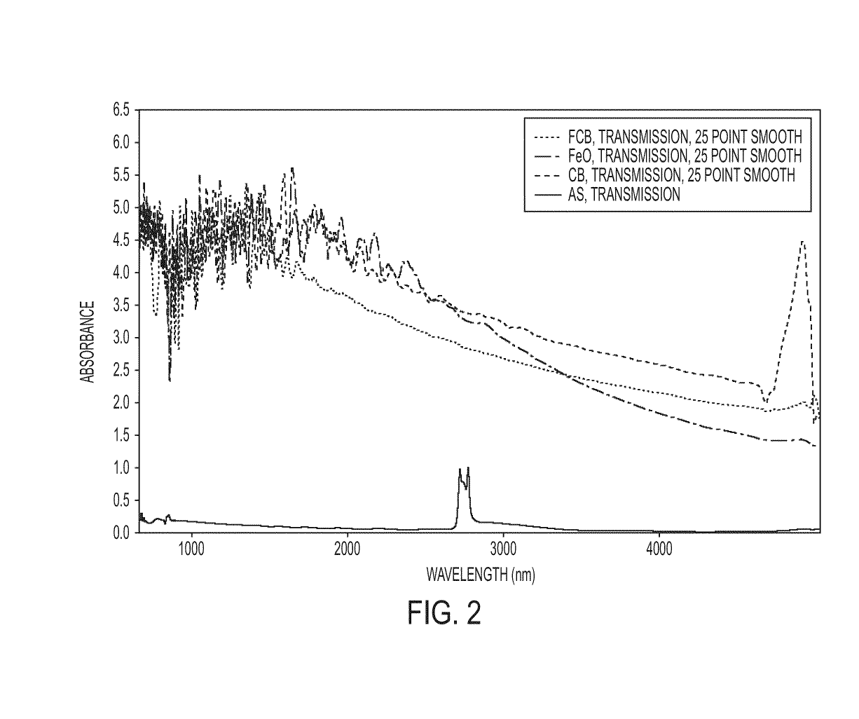

FIG. 2 is a graph illustrating absorbance as a function of wavelength for one example of a filler that can be used in accordance with the present disclosure.

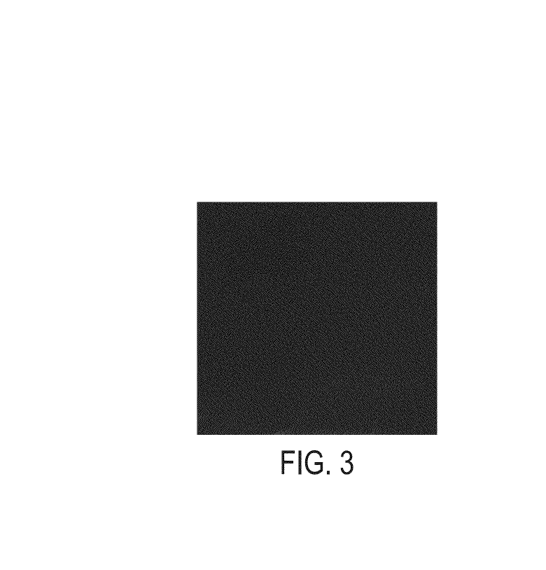

FIG. 3 is a photograph of one embodiment of a cured surface layer in accordance with the present disclosure.

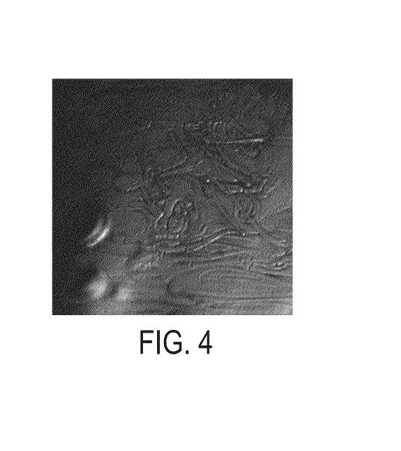

FIG. 4 is a photograph of a comparative, uncured surface layer.

### DETAILED DESCRIPTION

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The term “room temperature” refers to 25° C.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value. For example, the term “about 2” also discloses the value “2” and the range “from about 2 to about 4” also discloses the range “from 2 to 4.”

FIG. 1 illustrates a system for variable lithography in which the ink compositions of the present disclosure may be used. The system 10 comprises an imaging member 12. The imaging member comprises a substrate 22 and a reimageable surface layer 20. The surface layer is the outermost layer of the imaging member, i.e. the layer of the imaging member furthest from the substrate. As shown here, the substrate 22 is in the shape of a cylinder; however, the substrate may also be in a belt form, etc. Note that the surface layer is usually a different material compared to the substrate, as they serve different functions.

In the depicted embodiment the imaging member 12 rotates counterclockwise and starts with a clean surface. Disposed at a first location is a dampening fluid subsystem 30, which uniformly wets the surface with dampening fluid 32 to form a layer having a uniform and controlled thickness. Ideally the dampening fluid layer is between about 0.15 micrometers and about 1.0 micrometers in thickness, is uniform, and is without pinholes. As explained further below, the composition of the dampening fluid aids in leveling and layer thickness uniformity. A sensor 34, such as an in-situ non-contact laser gloss sensor or laser contrast sensor, is used to confirm the uniformity of the layer. Such a sensor can be used to automate the dampening fluid subsystem 30.

At optical patterning subsystem 36, the dampening fluid layer is exposed to an energy source (e.g. a laser) that selectively applies energy to portions of the layer to image-wise evaporate the dampening fluid and create a latent “negative” of the ink image that is desired to be printed on the receiving substrate. Image areas are created where ink is desired, and non-image areas are created where the dampening fluid remains. An optional air knife 44 is also shown here to control airflow over the surface layer 20 for the purpose of maintaining clean dry air supply, a controlled air temperature, and reducing dust contamination prior to inking. Next, an ink composition is applied to the imaging member using inker subsystem 46. Inker subsystem 46 may consist of a “keyless” system using an anilox roller to meter an offset ink composition onto one or more forming rollers 46A, 46B. The ink coposition is applied to the image areas to form an ink image.

A rheology control subsystem 50 partially cures or tacks the ink image. This curing source may be, for example, an ultraviolet light emitting diode (UV-LED) 52, which can be focused as desired using optics 54. Another way of increasing the cohesion and viscosity employs cooling of the ink composition. This could be done, for example, by blowing cool air over the reimageable surface from jet 58 after the ink composition has been applied but before the ink composition is transferred to the final substrate. Alternatively, a heating element 59 could be used near the inker subsystem 46 to maintain a first temperature and a cooling element 57 could be used to maintain a cooler second temperature near the nip 16.

The ink image is then transferred to the target or receiving substrate 14 at transfer subsystem 70. This is accomplished by passing a recording medium or receiving substrate 14, such as paper, through the nip 16 between the impression roller 18 and the imaging member 12.

Finally, the imaging member should be cleaned of any residual ink or dampening fluid. Most of this residue can be easily removed quickly using an air knife 77 with sufficient air flow. Removal of any remaining ink can be accomplished at cleaning subsystem 72.

The imaging member surface generally has a tailored topology. Put another way the surface has a micro-roughened surface structure to help retain fountain solution/dampening fluid in the non-image areas. These hillocks and pits that make up the surface enhance the static or dynamic surface energy forces that attract the fountain solution to the surface. This reduces the tendency of the fountain solution to be forced away from the surface by roller nip action. The imaging member plays multiple roles in the variable data lithography printing process, which include: (1) wetting with the fountain solution, (2) creation of the latent image, (3) inking with the offset ink, and (4) enabling the ink to lift off and be transferred to the receiving substrate. Some desirable qualities for the imaging member, particularly its surface, include high tensile strength to increase the useful service lifetime of the imaging member. The surface layer should also weakly adhere to the ink, yet be wettable with the ink, to promote both uniform inking of image areas and to promote subsequent transfer of the ink from the surface to the receiving substrate. In addition, the imaging member surface layer is usually casted on a casting mold to obtain the desired topology. Some materials require the presence of a release layer (e.g. parylene or fluoropolymer) on the casting mold to easiliy separate the surface layer from the mold. It would be desirable if the imaging member surface did not require a release layer to be present on the casting mold, to decrease the cost and complexity of the fabrication process.

The imaging members of the present disclosure include a surface layer that meets these requirements. In particular, the surface layer 20 comprises a silicone rubber and a heat-treated carbon black filler. This allows the surface layer to efficiently absorb energy, which aids in dissipating fountain solution from the image areas in which ink is to be applied.

The term “silicone” is well understood in the arts and refers to polyorganosiloxanes having a backbone formed from silicon and oxygen atoms and sidechains containing carbon and hydrogen atoms. Other functional groups may be present in the silicone rubber, for example vinyl, nitrogen-containing, mercapto, hydride, and silanol groups, which are used to link siloxane chains together during crosslinking. The sidechains of the polyorganosiloxane can be alkyl or aryl.

The term “alkyl” as used herein refers to a radical which is composed entirely of carbon atoms and hydrogen atoms which is fully saturated. The alkyl radical may be linear, branched, or cyclic. Linear alkyl radicals generally have the formula —CₙH₂ₙ₊₁.

The term “aryl” refers to an aromatic radical composed entirely of carbon atoms and hydrogen atoms. When aryl is described in connection with a numerical range of carbon atoms, it should not be construed as including substituted aromatic radicals. For example, the phrase “aryl containing from 6 to 10 carbon atoms” should be construed as referring to a phenyl group (6 carbon atoms) or a naphthyl group (10 carbon atoms) only, and should not be construed as including a methylphenyl group (7 carbon atoms).

Desirably, the silicone rubber is solution and/or dispersion coatable, which permits easy fabrication of the surface layer. In addition, the silicone rubber may be room temperature vulcanizable, or in other words uses a platinum catalyst for curing. In particular embodiments, the silicone rubber is a poly(dimethyl siloxane) containing functional groups such as vinyl or hydride that permit addition crosslinking. Such silicone rubbers are commercially available, for example as ELASTOSIL RT 622 from Wacker.

In particular embodiments, the silicone rubber is a fluorosilicone. The term “fluorosilicone” as used herein refers to polyorganosiloxanes having a backbone formed from silicon and oxygen atoms and sidechains containing carbon, hydrogen, and fluorine atoms. At least one fluorine atom is present in the sidechain. The sidechains can be linear, branched, cyclic, or aromatic. The fluorosilicone may also contain functional groups, such as amino groups, which permit addition crosslinking. When the crosslinking is complete, such groups become part of the backbone of the overall fluorosilicone. Fluorosilicones are commercially available, for example CF1-3510 from NuSil.

In the fluorosilicones of the present disclosure, at least 75% of the siloxane units are fluorinated. The percentage of fluorinated siloxane units can be determined by considering that each silicon atom contains two possible sidechains. The percentage is calculated as the number of sidechains having at least one fluorine atom divided by the total number of sidechains (i.e. twice the number of silicon atoms).

In other embodiments, the silicone rubber is a fluoroelastomer-silicone composite. The silicone rubber is formed from the reaction of a fluoroelastomer with other silane-containing compounds. The term “fluoroelastomer” refers to a copolymer that contains monomers exclusively selected from the group consisting of hexafluoropropylene (HFP), tetrafluoroethylene (TFE), vinylidene fluoride (VDF), perfluoromethyl vinyl ether (PMVE), and ethylene (ET). The term copolymer here refers to polymers made from two or more monomers. Fluoroelastomers usually contain two or three of these monomers, and have a fluorine content of from about 60 wt % to about 70 wt %. Put another way, a fluoroelastomer has the structure of Formula (1):

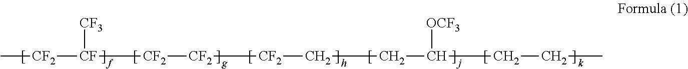

where f is the mole percentage of HFP, g is the mole percentage of TFE, h is the mole percentage of VDF, j is the mole percentage of PMVE, and k is the mole percentage of ET; f+g+h+j+k is 100 mole percent; f, g, h, j, and k can individually be zero, but f+g+h+j must be at least 50 mole percent. Please note that Formula (1) only shows the structure of each monomer and their relative amounts, and should not be construed as describing the bonds within the fluoroelastomer (i.e. not as having five blocks). Fluoroelastomers generally have superior chemical resistance and good physical properties. Exemplary fluoroelastomers are available as Tecnoflon P959 from Solvay or Dai-el G-621 from Daikin (a VDF-TFE-HFP terpolymer).

An exemplary silane-containing compound that can be reacted with the fluoroelastomer is an oxyaminosilane. The term “oxyaminosilane” refers to a compound that has at least one silicon atom covalently bonded to an oxygen atom and that has at least one amino group (—NH₂). The oxygen atom may be part of a hydrolyzable group, such as an alkoxy or hydroxyl group. The amino group is not necessarily covalently bonded to the silicon atom, but may be joined through a linking group. A general formula for an oxyaminosilane is provided in Formula (2):

Si(OR)ₚR′_{q}(-L-NH₂)₄-p-q Formula (2)

where R is hydrogen or alkyl; p is an integer from 1 to 3; q is an integer from 0 to 2; and L is a linking group. More desirably, p is 2 or 3. Of course, 4-p-q must be at least 1.

The term “alkoxy” refers to an alkyl radical (usually linear or branched) bonded to an oxygen atom, e.g. having the formula —OCₙH₂ₙ₊₁.

Exemplary oxyaminosilanes include [3-(2-aminoethylamino)propyl] trimethoxysilane and 3-aminopropyl trimethoxysilane. In 3-aminopropyl trimethoxysilane, the propyl chain is the linking group. These silanes are commercially available, for example from Sigma-Aldrich or UCT (sold as AO700). The amine functional group may be a primary, secondary, or tertiary amine. The nitrogen atom of an amino group can bond with the fluoroelastomer (i.e the oxygen atom will not bond with the fluoroelastomer). Another group of the oxyaminosilane may be used to react with the fluorinated oxysilane-terminated compound.

This reaction results in a crosslinked fluoroelastomer-silicone composite that has superior physical properties compared to other curing means. Without wishing to be bound by theory, it is believed that this crosslinking takes the form of a partially condensed interpenetrating sol-gel network. In this regard, the oxygen atoms of the oxyaminosilane/oligomer can react with each other as well, so that additional bonds are formed between fluoroelastomers. However, the nitrogen atom of the amino group cannot replace an oxygen atom, and can only react with the fluoroelastomer.

The silicone rubber is loaded with an infrared-absorbing filler. The infrared-absorbing filler is able to absorb energy from the infra-red portion of the spectrum (having a wavelength of from about 750 nm to about 1000 nm). This aids in efficient evaporation of the fountain solution. Specifically, the filler used herein is a heat treated carbon black. The carbon black may have an average particle size of from about 2 nanometers to about 10 microns. Carbon black disperses easily and does not leach out after the silicone rubber is cured.

The infrared-absorbing filler (i.e. carbon black) may make up from about 5 to about 20 weight percent of the surface layer, including from about 7 to about 15 weight percent. The silicone rubber may make up from about 80 to about 95 weight percent of the surface layer, including from about 85 to about 93 weight percent.

As mentioned above, in the present disclosure a heat treated carbon black is used. In this regard, carbon black powders are known to contain sulfur in trace quantities which are difficult to detect, even in “low-sulfur” grades of carbon black. Sulfur is known to be a platinum catalyst poison, or in other words will inhibit platinum from acting as a catalyst. This can be a problem when carbon black is used in combination with a silicone rubber containing a platinum cure catalyst.

In the present disclosure, the carbon black is heat treated prior to being combined with the silicone rubber. Without being bound by theory, it is believed that the heat treatment reduces any free sulfur content in the carbon black, and thus enhances curing of the silicone by reducing platinum catalyst poisoning.

In this regard, sulfur has a boiling point of 445° C. Thus, the carbon black should be heated above this temperature to fully extract any sulfur present in the carbon black. In embodiments, the carbon black is heat treated at a temperature of at least 445° C. In some embodiments, the treatment temperature is at least 550° C., including about 600° C. The carbon black may be heat treated for a period of about 30 minutes to about 2 hours.

It should be noted that carbon black is generally produced by the incomplete combustion of hydrocarbons, or by charring of other organic materials. Carbon black is commercially available from several different sources, e.g. Continental Carbon, Cabot, etc. The heat treatment described above is performed on the carbon black received from such commercial sources. Put another way, the combustion or charring used to produce carbon black is not considered to be within the scope of the heat treatment described above. In addition, the carbon black is heat treated by itself, or in other words without the presence of any additives. The goal of the heat treatment is to remove the sulfur, not to functionalize the carbon black.

If desired, the surface layer may also include other fillers, such as silica. Silica can help increase the tensile strength of the surface layer and increase wear resistance. Silica may be present in an amount of from about 2 to about 30 weight percent of the surface layer, including from about 5 to about 30 weight percent.

The surface layer may have a thickness of from about 0.5 microns (μm) to about 4 millimeters (mm), depending on the requirements of the overall printing system.

Methods of fabricating the imaging member surface layer are also disclosed. The methods may include depositing a surface layer composition upon a mold; and curing the surface layer composition at room temperature or an elevated temperature. The surface layer composition includes a silicone rubber and the heat treated carbon black described above. The mold does not require a release layer. The curing may be performed at room temperature. The curing may occur for a time period of from about 15 minutes to about 3 hours. The surface layer composition may further comprise a catalyst, such as a platinum catalyst.

Further disclosed are processes for variable lithographic printing. The processes include applying a fountain solution/dampening fluid to an imaging member comprising an imaging member surface. A latent image is formed by evaporating the fountain solution from selective locations on the imaging member surface to form hydrophobic non-image areas and hydrophilic image areas; developing the latent image by applying an ink composition to the hydrophilic image areas; and transferring the developed latent image to a receiving substrate. The imaging member surface comprises a silicone rubber and the heat treated carbon black described above

The present disclosure contemplates a system where the dampening fluid is hydrophobic (i.e. non-aqueous) and the ink somewhat hydrophilic (having a small polar component). This system can be used with the imaging member surface layer of the present disclosure. Generally speaking, the variable lithographic system can be described as comprising an ink composition, a dampening fluid, and an imaging member surface layer, wherein the dampening fluid has a surface energy alpha-beta coordinate which is within the circle connecting the alpha-beta coordinates for the surface energy of the ink and the surface energy of the imaging member surface layer. In particular embodiments, the dampening fluid has a total surface tension greater than 10 dynes/cm and less than 75 dynes/cm with a polar component of less than 50 dynes/cm. In some more specific embodiments, the dampening fluid has a total surface tension greater than 15 dynes/cm and less than 30 dynes/cm with a polar component of less than 5 dynes/cm. The imaging member surface layer may have a surface tension of less than 30 dynes/cm with a polar component of less than 2 dynes/cm.

By choosing the proper chemistry, it is possible to devise a system where both the ink and the dampening fluid will wet the imaging member surface, but the ink and the dampening fluid will not mutually wet each other. The system can also be designed so that it is energetically favorable for dampening fluid in the presence of ink residue to actually lift the ink residue off of the imaging member surface by having a higher affinity for wetting the surface in the presence of the ink. In other words, the dampening fluid could remove microscopic background defects (e.g. <1 radius) from propagating in subsequent prints.

The dampening fluid should have a slight positive spreading coefficient so that the dampening fluid wets the imaging member surface. The dampening fluid should also maintain a spreading coefficient in the presence of ink, or in other words the dampening fluid has a closer surface energy value to the imaging member surface than the ink does. This causes the imaging member surface to value wetting by the dampening fluid compared to the ink, and permits the dampening fluid to lift off any ink residue and reject ink from adhering to the surface where the laser has not removed dampening fluid. Next, the ink should wet the imaging member surface in air with a roughness enhancement factor (i.e. when no dampening fluid is present on the surface). It should be noted that the surface may have a roughness of less than 1 μm when the ink is applied at a thickness of 1 to 2 Desirably, the dampening fluid does not wet the ink in the presence of air. In other words, fracture at the exit inking nip should occur where the ink and the dampening fluid interface, not within the dampening fluid itself. This way, dampening fluid will not tend to remain on the imaging member surface after ink has been transferred to a receiving substrate. Finally, it is also desirable that the ink and dampening fluid are chemically immiscible such that only emulsified mixtures can exist.

The role of the dampening fluid is to provide selectivity in the imaging and transfer of ink to the receiving substrate. When an ink donor roll in the ink source of FIG. 1 contacts the dampening fluid layer, ink is only applied to areas on the imaging member that are dry, i.e. not covered with dampening fluid.

It is contemplated that the dampening fluid which is compatible with the ink compositions of the present disclosure is a volatile hydrofluoroether (HFE) liquid or a volatile silicone liquid. These classes of fluids provides advantages in the amount of energy needed to evaporate, desirable characteristics in the dispersive/polar surface tension design space, and the additional benefit of zero residue left behind once evaporated. The hydrofluoroether and silicone are liquids at room temperature, i.e. 25° C.

In specific embodiments, the volatile hydrofluoroether liquid has the structure of Formula (1):

CₘHₚF₂ₘ₊₁₋ₚ—O—CₙH_{q}F_{2n+1-q} Formula (I)

wherein m and n are independently integers from 1 to about 9; and p and q are independently integers from 0 to 19. As can be seen, generally the two groups bound to the oxygen atom are fluoroalkyl groups.

In particular embodiments, q is zero and p is non-zero. In these embodiments, the right-hand side of the compound of Formula (I) becomes a perfluoroalkyl group. In other embodiments, q is zero and p has a value of 2 m+1. In these embodiments, the right-hand side of the compound of Formula (I) is a perfluoroalkyl group and the left-hand side of the compound of Formula (I) is an alkyl group. In still other embodiments, both p and q are at least 1.

In this regard, the term “fluoroalkyl” as used herein refers to a radical which is composed entirely of carbon atoms and hydrogen atoms, in which one or more hydrogen atoms may be (i.e. are not necessarily) substituted with a fluorine atom, and which is fully saturated. The fluoroalkyl radical may be linear, branched, or cyclic. It should be noted that an alkyl group is a subset of fluoroalkyl groups.

The term “perfluoroalkyl” as used herein refers to a radical which is composed entirely of carbon atoms and fluorine atoms which is fully saturated and of the formula —CₙF₂ₙ₊₁. The perfluoroalkyl radical may be linear, branched, or cyclic. It should be noted that a perfluoroalkyl group is a subset of fluoroalkyl groups, and cannot be considered an alkyl group.

In particular embodiments, the hydrofluoroether has the structure of any one of Formulas (I-a) through (I-h):

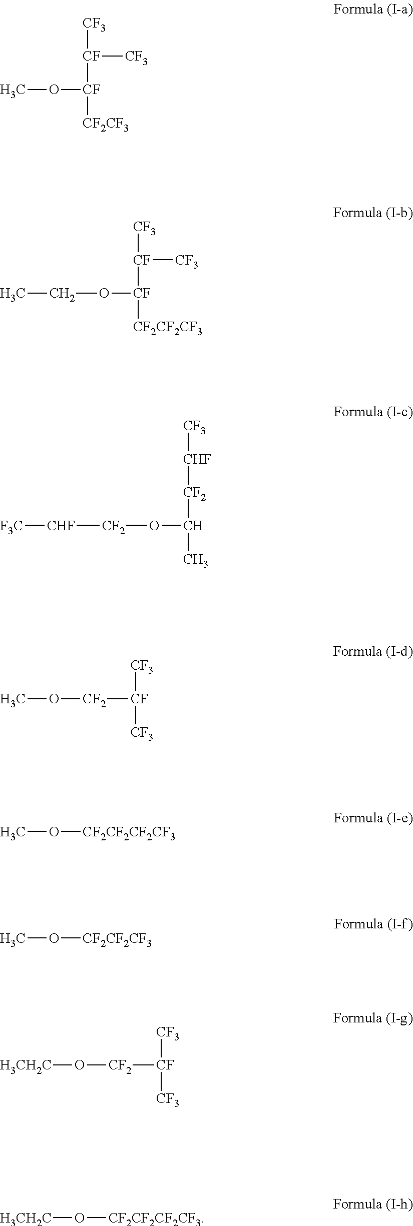

Of these formulas, Formulas (I-a), (I-b), (I-d), (I-e), (I-f), (I-g), and (I-h) have one alkyl group and one perfluoroalkyl group, either branched or linear. In some terminology, they are also called segregated hydrofluoroethers. Formula (I-c) contains two fluoroalkyl groups and is not considered a segregated hydrofluoroether.

Formula (I-a) is also known as 1,1,1,2,2,3,4,5,5,5-decafluoro-3-methoxy-4-(trifluoromethyl)pentane and has CAS#132182-92-4. It is commercially available as Novec™7300.

Formula (I-b) is also known as 3-ethoxy-1,1,1,2,3,4,4,5,5,6,6,6-dodecafluoro-2-(trifluoromethyl)hexane and has CAS#297730-93-9. It is commercially available as Novec™ 7500.

Formula (I-c) is also known as 1,1,1,2,3,3-Hexafluoro-4-(1,1,2,3,3,3-hexafluoropropoxy)pentane and has CAS#870778-34-0. It is commercially available as Novec™ 7600.

Formula (I-d) is also known as methyl nonafluoroisobutyl ether and has CAS#163702-08-7. Formula (I-e) is also known as methyl nonafluorobutyl ether and has CAS#163702-07-6. A mixture of Formulas (I-d) and (1-e) is commercially available as Novec™ 7100. These two isomers are inseparable and have essentially identical properties.

Formula (I-f) is also known as 1-methoxyheptafluoropropane or methyl perfluoropropyl ether, and has CAS#375-03-1. It is commercially available as Novec™7000.

Formula (I-g) is also known as ethyl nonafluoroisobutyl ether and has CAS#163702-05-4. Formula (I-h) is also known as ethyl nonafluorobutyl ether and has CAS#163702-06-5. A mixture of Formulas (I-g) and (I-h) is commercially available as Novec™ 7200 or Novec™ 8200. These two isomers are inseparable and have essentially identical properties.

It is also possible that similar compounds having a cyclic aromatic backbone with perfluoroalkyl sidechains can be used. In particular, compounds of Formula (A) are contemplated:

Ar—(CₖF₂ₖ₊₁) Formula (A)

wherein Ar is an aryl or heteroaryl group; k is an integer from 1 to about 9; and t indicates the number of perfluoroalkyl sidechains, t being from 1 to about 8.

The term “heteroaryl” refers to a cyclic radical composed of carbon atoms, hydrogen atoms, and a heteroatom within a ring of the radical, the cyclic radical being aromatic. The heteroatom may be nitrogen, sulfur, or oxygen. Exemplary heteroaryl groups include thienyl, pyridinyl, and quinolinyl. When heteroaryl is described in connection with a numerical range of carbon atoms, it should not be construed as including substituted heteroaromatic radicals. Note that heteroaryl groups are not a subset of aryl groups.

Hexafluoro-m-xylene (HFMX) and hexafluoro-p-xylene (HFPX) are specifically contemplated as being useful compounds of Formula (A) that can be used as low-cost dampening fluids. HFMX and HFPX are illustrated below as Formulas (A-a) and (A-b):

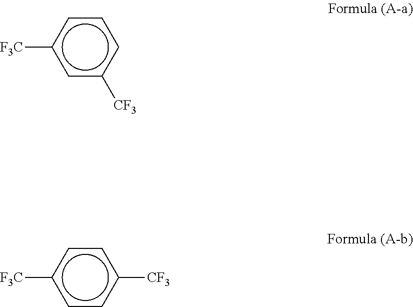

It should be noted any co-solvent combination of fluorinated damping fluids can be used to help suppress non-desirable characteristics such as a low flammability temperature.

Alternatively, the dampening fluid solvent is a volatile silicone liquid. In some embodiments, the volatile silicone liquid is a linear siloxane having the structure of Formula (II):

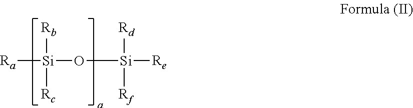

wherein Rₐ, R_{b}, R_{c}, R_{d}, Rₑ, and R_{f} are each independently hydrogen, alkyl, or perfluoroalkyl; and a is an integer from 1 to about 5. In some specific embodiments, Rₐ, R_{b}, R_{b}, R_{d}, Rₑ, and R_{f} are all alkyl. In more specific embodiments, they are all alkyl of the same length (i.e. same number of carbon atoms).

Exemplary compounds of Formula (II) include hexamethyldisiloxane and octamethyltrisiloxane, which are illustrated below as Formulas (II-a) and (II-b):

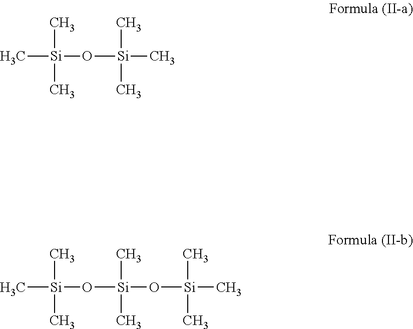

In other embodiments, the volatile silicone liquid is a cyclosiloxane having the structure of Formula (III):

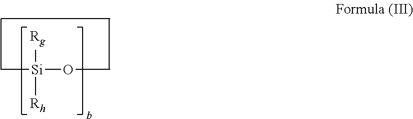

wherein each R_{g} and Rₕ is independently hydrogen, alkyl, or perfluoroalkyl; and b is an integer from 3 to about 8. In some specific embodiments, all of the R_{g} and Rₕ groups are alkyl. In more specific embodiments, they are all alkyl of the same length (i.e. same number of carbon atoms).

Exemplary compounds of Formula (III) include octamethylcyclotetrasiloxane (aka D4) and decamethylcyclopentasiloxane (aka D5), which are illustrated below as Formulas (III-a) and (III-b):

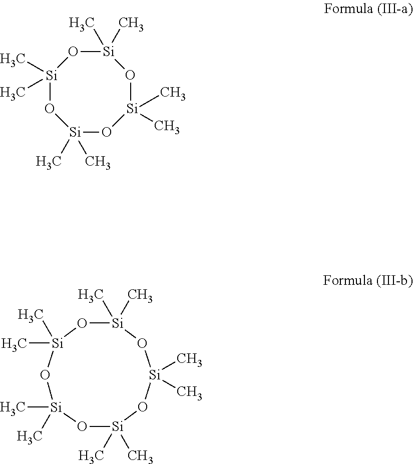

In other embodiments, the volatile silicone liquid is a branched siloxane having the structure of Formula (IV):

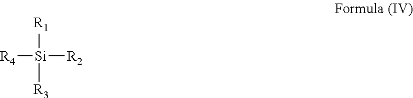

wherein R₁, R₂, R₃, and R₄ are independently alkyl or —OSiR₁R₂R₃.

An exemplary compound of Formula (IV) is methyl trimethicone, also known as methyltris(trimethylsiloxy)silane, which is commercially available as TMF-1.5 from Shin-Etsu, and shown below with the structure of Formula (IV-a):

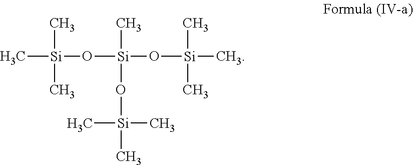 [SMILES: C[Si](C)(C)O[Si](C)(O[Si](C)(C)C)O[Si](C)(C)C]

Any of the above described hydrofluoroethers/perfluorinated compounds are miscible with each other. Any of the above described silicones are also miscible with each other. This allows for the tuning of the dampening fluid for optimal print performance or other characteristics, such as boiling point or flammability temperature. Combinations of these hydrofluoroether and silicone liquids are specifically contemplated as being within the scope of the present disclosure. It should also be noted that the silicones of Formulas (II), (Ill), and (IV) are not considered to be polymers, but rather discrete compounds whose exact formula can be known.

In particular embodiments, it is contemplated that the dampening fluid comprises a mixture of octamethylcyclotetrasiloxane (D4) and decamethylcyclopentasiloxane (D5). Most silicones are derived from D4 and D5, which are produced by the hydrolysis of the chlorosilanes produced in the Rochow process. The ratio of D4 to D5 that is distilled from the hydrolysate reaction is generally about 85% D4 to 15% D5 by weight, and this combination is an azeotrope.

In particular embodiments, it is contemplated that the dampening fluid comprises a mixture of octamethylcyclotetrasiloxane (D4) and hexamethylcyclotrisiloxane (D3), the D3 being present in an amount of up to 30% by total weight of the D3 and the D4. The effect of this mixture is to lower the effective boiling point for a thin layer of dampening fluid.

These volatile hydrofluoroether liquids and volatile silicone liquids have a low heat of vaporization, low surface tension, and good kinematic viscosity.

The ink compositions contemplated for use with the present disclosure generally include a colorant and a plurality of selected curable compounds. The curable compounds can be cured under ultraviolet (UV) light to fix the ink in place on the final receiving substrate. As used herein, the term “colorant” includes pigments, dyes, quantum dots, mixtures thereof, and the like. Dyes and pigments have specific advantages. Dyes have good solubility and dispersibility within the ink vehicle. Pigments have excellent thermal and light-fast performance. The colorant is present in the ink composition in any desired amount, and is typically present in an amount of from about 10 to about 40 weight percent (wt %), based on the total weight of the ink composition, or from about 20 to about 30 wt %. Various pigments and dyes are known in the art, and are commercially available from suppliers such as Clariant, BASF, and Ciba, to name just a few.

The ink compositions may have a viscosity of from about 5,000 to about 300,000 centipoise at 25° C. and a shear rate of 5 sec⁻¹, including a viscosity of from about 15,000 to about 250,000 cps. The ink compositions may have a viscosity of from about 2,000 to about 90,000 centipoise at 25° C. and a shear rate of 50 sec⁻¹, including a viscosity of from about 5,000 to about 65,000 cps. The shear thinning index, or SHI, is defined in the present disclosure as the ratio of the viscosity of the ink composition at two different shear rates, here 50 sec⁻¹ and 5 sec⁻¹. This may be abbreviated as SHI (50/5). The SHI (50/5) may be from about 0.10 to about 0.60 for the ink compositions of the present disclosure, including from about 0.35 to about 0.55. These ink compositions may also have a surface tension of at least about 25 dynes/cm at 25° C., including from about 25 dynes/cm to about 40 dynes/cm at 25° C. These ink compositions possess many desirable physical and chemical properties. They are compatible with the materials with which they will come into contact, such as the dampening fluid, the surface layer of the imaging member, and the final receiving substrate. They also have the requisite wetting and transfer properties. They can be UV-cured and fixed in place. They also have a good viscosity; conventional offset inks usually have a viscosity above 50,000 cps, which is too high to use with nozzle-based inkjet technology. In addition, one of the most difficult issues to overcome is the need for cleaning and waste handling between successive digital images to allow for digital imaging without ghosting of previous images. These inks are designed to enable very high transfer efficiency instead of ink splitting, thus overcoming many of the problems associated with cleaning and waste handling. The ink compositions of the present disclosure do not gel, whereas regular offset inks made by simple blending do gel and cannot be used due to phase separation.

Aspects of the present disclosure may be further understood by referring to the following examples. The examples are illustrative, and are not intended to be limiting embodiments thereof.

### EXAMPLES

### Heat-Treated Carbon Black

Carbon black powder (Cabot Carbon Black XC-72) was placed in a stainless steel tray in a thin layer and heated to 600° C. for 1 hour. No additives were included with the carbon black in the tray during the heat treatment. During this process, it is believed that sulfur is oxidized to sulfur oxides (SOx) and some of the carbon black is oxidized to carbon dioxide. A total weight loss of 20% was determined to have occurred through the heat treatment process.

Afterwards, the infrared absorbing spectrum of the thermally treated carbon black (FCB) was compared to the infrared absorbing spectra of untreated carbon black (CB), iron oxide (FeO), and AS (Kaopalite XDA Hydrous Alumino-silicate, supplied by Imerys). FIG. 2 is a graph illustrating the infrared absorbing spectra of these materials. FIG. 2 shows that there was no substantial change in infrared absorption after heat treatment between the CB and FCB lines, especially in the near-infrared range.

### EXAMPLES 1-3

The heat-treated carbon black described above was incorporated into Toray RT 622 elastomer. RT 622 is a pourable, two component silicone rubber that vulcanizes at room temperature. Part A has polydimethylsiloxane with functional groups and Part B has polydimethylsiloxane with functional groups and a platinum catalyst. The platinum catalyst functions as a curing agent. Part A, solvent, and filler were milled. Inhibitor is added separately.

In Example 1, 3% by weight carbon black was loaded into RT 622 within a ball milling jar with an appropriate amount of solvent to obtain a desired viscosity range, e.g., 100 cP to 500 cP. The solvent may comprise MEK, MIBK, or Toluene. The material was tumble milled for a period of from about 14 to about 16 hours. The material was removed and a catalyst agent and an inhibitor were then added. The elastomer was cured at room temperature for 4 to 6 hours to form an imaging plate.

In Example 2, the procedure of Example 1 was followed except 6% carbon black was included.

In Example 3, the procedure of Example 1 was followed except 10% carbon black was included.

FIG. 3 is a photograph of the imaging plate of Example 2. The homogeneity displayed in FIG. 3 indicates fully cured silicone. Curing or non-curing may be measured in terms of % extractables. In particular, a sample may be weighed and immersed in a solvent. The solvent is decanted and the sample weighed again. The % extractable is a measurement for an amount of material that is not crosslinked and fixed into a permanently formed polymer network. The extractables value for the silicone loaded with the fired carbon black is less than 15%, which indicates a sufficiently crosslinked silicone material, while the silicone loaded with the as received carbon black had an extractables level over 30%. This is indicative of an uncured or insufficiently cured silicone material.

### COMPARATIVE EXAMPLES 4-6

In Comparative Example 4, the procedure of Example 1 was followed except the carbon black was not heat treated.

In Comparative Example 5, the procedure of Example 2 was followed except the carbon black was not heat treated.

In Comparative Example 6, the procedure of Example 3 was followed except the carbon black was not heat treated.

FIG. 4 is a photograph of the imaging plate of Example 4. The inhomogeneity indicates that the silicone was not cured. The imaging plate was allowed to cure for 2 days, but curing was not observed after that extended period. A comparison of FIG. 4 with FIG. 3 indicates that the composition including heat-treated carbon black achieved better curing despite higher filler loading

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

What is claimed is:

1. An imaging member comprising a surface layer;
wherein the surface layer comprises a silicone rubber and heat treated carbon black; and
wherein the carbon black has been heat treated at a temperature of at least 445° C.

2. The imaging member of claim 1, wherein the silicone rubber is present in an amount of from about 80 to about 95 weight percent.

3. The imaging member of claim 1, wherein the carbon black is present in an amount of from about 5 to about 20 weight percent.

4. The imaging member of claim 1, wherein the carbon black has an average particle size of from about 2 nanometers to about 10 microns.

5. The imaging member of claim 1, wherein the carbon black has been heat treated at a temperature of at least 550° C.

6. The imaging member of claim 1, wherein the carbon black has been heat treated for a period of from about 30 minutes to about 2 hours.

7. The imaging member of claim 1, wherein the carbon black has been heat treated at a temperature of about 600° C. for a period of about 1 hour.

8. A method of fabricating an imaging member surface layer, comprising:
depositing a surface layer composition upon a mold; and
curing the surface layer composition;
wherein the surface layer composition comprises a silicone material and a heat treated carbon black; and
wherein the carbon black has been heat treated at a temperature of at least 445° C.

9. The method of claim 8, wherein the curing occurs at about room temperature.

10. The method of claim 8, wherein the surface layer composition further comprises a catalyst.

11. The method of claim 10, wherein the catalyst is a platinum catalyst.

12. The method of claim 8, wherein the carbon black is present in an amount of from about 5 to about 20 weight percent

13. The method of claim 8, wherein the carbon black has an average particle size of from about 2 nanometers to about 10 microns.

14. The method of claim 8, wherein the vulcanized surface layer has a thickness of from about 0.5 microns to about 4 millimeters.

15. A process for variable lithographic printing, comprising:
applying a fountain solution to an imaging member comprising an imaging member surface;
forming a latent image by evaporating the fountain solution from selective locations on the imaging member surface to form hydrophobic non-image areas and hydrophilic image areas;
developing the latent image by applying an ink composition to the hydrophilic image areas; and
transferring the developed latent image to a receiving substrate;
wherein the imaging member surface comprises a silicone rubber and heat treated carbon black; and
wherein the carbon black has been heat treated at a temperature of at least 445° C.

16. The process of claim 15, wherein the fountain solution comprises a siloxane compound.

17. The process of claim 15, wherein the siloxane compound is octamethylcyclotetrasiloxane.

18. The process of claim 15, wherein the carbon black is present in an amount of from about 5 to about 20 weight percent.

19. The process of claim 15, wherein the carbon black has an average particle size of from about 2 nanometers to about 10 microns.
